(19) United States
(12) Patent Application Publication
(10) Pub. No.: US 2019/0122254 A1
(43) Pub. Date: Apr. 25, 2019

(54) METHODS AND TOOLS FOR A/B TESTING LOGIC ON EMAILS

(71) Applicant: Clutch Holdings, LLC, Ambler, PA (US)

(72) Inventors: Timothy Duquette, Philadelphia, PA (US); Daniel Guy, Swiftwater, PA (US); Leendert-Henk Gravendeel, Gravendeel (NL)

(73) Assignee: Clutch Holdings, LLC, Ambler, PA (US)

(21) Appl. No.: 16/165,456

(22) Filed: Oct. 19, 2018

Related U.S. Application Data
(60) Provisional application No. 62/574,238, filed on Oct. 19, 2017.

(51) Int. Cl. G06Q 30/02; H04L 12/58

(52) U.S. Cl. CPC G06Q 30/0243; H04L 51/34

(57) ABSTRACT

Bayesian A/B testing tools and methods for email campaigns are provided. The Bayesian methods and tools disclosed herein determine which version of an email is better than another to enable accurate Bayesian A/B testing on the emails.

### CROSS REFERENCE TO RELATED APPLICATIONS

This application claims the benefit of U.S. Provisional Application Ser. No. 62/574,238 filed Oct. 19, 2017, the entire contents of which are incorporated by reference herein.

### BACKGROUND

### 1. Field of the Invention

Bayesian A/B testing tools and methods for email campaigns are provided. The Bayesian methods and tools disclosed herein determine which version of an email is better than another to enable accurate Bayesian A/B testing on the emails.

### 2. Description of Related Art

Electronic mail or “email” marketing is an important aspect of an overall marketing strategy. Systems and methods have been proposed that automatically generate and distribute emails.

When using such systems, the ability to create impactful emails to drive a specific marketing goal is important. Thus, it is important to determine the value of a specific email campaign and its impact to the overall marketing campaign.

It has been determined by the present disclosure that there is a need in the market place for new tools to implement experiments to determine if their communication efforts are having an impact on a specific marketing goal as well as test versions of communications to maximize that impact.

### SUMMARY

The A/B testing tools and methods allow implementation of experiments to determine communication efforts are having an impact on a specific marketing goal as well as test versions of communications to maximize that impact. The tools and methods use learnings of experiments to make incremental tweaks to content, channel, message, etc. Many small improvements over time will culminate in a large impact on overall campaign and marketing success in general. This will lead to an overall understanding if a communication strategy has a positive impact on marketing goals.

Advantageously, the A/B testing tools and methods of the present application solves difficult AB Testing problems related to email that are not encountered when AB Testing other content such as that in web pages or other live content.

The A/B testing tools and methods are easy to use and implement for all JavaScript Object Notation (JSON) such as JSON V2.

The A/B testing tools and methods can be used by companies interested in learning how to create smarter, more impactful communications to drive a specific marketing goal by willing to understand the value of any given marketing initiative down to a specific email campaign

The A/B testing tool and methods make use of new processes to provide these and other benefits.

For example, the A/B testing tools and methods include the ability to determine the audience size to send email. Since there is no agreed upon Bayesian approach to sample size calculation, the tool includes a custom-built logic that to determine sample size. Also, the tools and methods evaluate the probability and also evaluate the lift produced by picking the winning version.

The above-described and other features and advantages of the present disclosure will be appreciated and understood by those skilled in the art from the following detailed description, drawings, and appended claims.

### BRIEF DESCRIPTION OF THE FIGURES

FIG. 1 is a schematic depiction of an A/B testing tool and method according to the present disclosure;

FIG. 2 is a schematic depiction of an experiment setup and parameters for configuring an experiment using the tool of FIG. 1; and

FIG. 3 is a system diagram of an A/B testing tool and method according to the present disclosure.

### DETAILED DESCRIPTION

The A/B testing tools and methods of the present disclosure can be used when determining any number of different key performance indicators (KPI's). Various examples of KPI's that can be determined using the tools and methods of the present disclosure include, but are not limited to, average order value, total purchases, spend per customer, open rate, click through rate, and others. In each example, the present disclosure includes the use of sample size, probability, and lift.

As used in the examples below, B(a, b) refers to a Beta Distribution with shape parameters a, b.

NormSInv(P): returns X such that

$$P = {\int }_{- ∞}^{X} \frac{1}{\sqrt{2 π}} {e}^{\frac{{t}^{2}}{2}} dt$$

### Example of Tools and Methods of the Present Disclosure for Determining Average Order Value (AOV)

Required Inputs: AOV for A and B

Required Calculator Inputs: Historical AOV

This metric looks for the AOV in two groups and compares it. The AOV is defined as [total spend by all recipients]/[total amount of checkouts by all recipients].

A marketer might care about increasing AOV, as there could be some fixed costs associated with transactions, such as the time a cashier has to spend per transaction or shipping. A higher AOV means there is more revenue with the same amount of those fixed costs per transaction.

The tools and the methods of the present disclosure calculate AOV as follows:

### Sample Size

Where n=sample size, θ=aggregate AOV, λ=proportion of customers who made a purchase, α=confidence level, and δ=minimum detectable difference

$$p = 1.4 NormSInv ( 1 - ( \frac{1 - α}{2} ) )$$

$$q = 1.96 c = θ ( 1 - θ )$$

$$d = ( θ + δ ) ( 1 - ( θ + δ ) )$$

$$n = \frac{( 2 θ pq \sqrt{d} + {θ}^{2} {p}^{2} + {dq}^{2} )}{{λδ}^{2}}$$

### Probability P(A>B):

The AOV generated by an individual user i is given by rᵢ, where

rᵢ<−Expon(θ)

θ is the average order value of the subjects under test. P(A>B) is computed with Monte Carlo sampling:

Draw samples θ_{A}ⁱ, θ_{B}ⁱ for i=1, . . . , N from the Exponential distribution above.

Count the number of samples for which θ_{A}ⁱ>θ_{B}ⁱ

Divide this count by M

### Lift:

Where Δ_{A} is lift generated by version A, θ_{B} is the aggregate AOV from version B, and N is the number of samples in the simulation

Draw samples θ_{A}ⁱ, θ_{B}ⁱ for i=1, . . . , N from Exponential distribution Compute the following:

$${Δ}_{A} = \frac{{θ}_{B}}{N} {\sum }_{i = 0}^{N} ( {θ}_{A}^{i} - {θ}_{B}^{i} )$$

### Example of Tools and Methods of the Present Disclosure for Determining Total Purchases

Required Inputs: # of checkouts for A and B, Number of customers who received mailing in A and B, attribution period for A and B.

The transactions metric simply aims to increase the total amount of transactions. It is measured [total amount of checkouts]/[total amount of recipients]. The metric is divided by the total amount of recipients to account for possible differences in A/B or holdout/non-holdout sizes.

A marketer may use this metric to increase revenue by first increasing the amount of transactions, and focusing on increasing AOV later on.

The tools and the methods of the present disclosure calculate total purchases as follows:

### Sample Size:

Where n=sample size, λ=aggregate total purchases, α=confidence level, and δ=minimum detectable difference

$$p = 1.4 NormSInv ( 1 - ( \frac{1 - α}{2} ) )$$

$$q = 1.96$$

$$z = λδ$$

$$d = λ ( 1 + δ )$$

$$n = \frac{( 2 pq \sqrt{λ d} ) + ( λ {p}^{2} ) + ( {dq}^{2} ) )}{{z}^{2}}$$

### Probability P(A>B):

$$P ( {purchases}_{A} > {purchases}_{B} ) = {\sum }_{k = 0}^{{transactions}_{A} - 1} \frac{{( {recipients}_{A} + {recipients}_{B} )}^{- ( k + {transactions}_{B} )} {recipients}_{A}^{k} {recipients}_{B}^{{transactions}_{B}}}{( k + {transactions}_{B} ) B ( k + 1 , {transactions}_{B} )}$$

### Lift:

Where Δ_{A}=lift generated by version A

$${Δ}_{A} = \frac{{transactions}_{A} * {recipients}_{B}}{{transactions}_{B} * {recipients}_{A}}$$

### Example of Tools and Methods of the Present Disclosure for Determining Spend Per Customer

Required Inputs: Proportion of customers in A and B that made a purchase, AOV for A and B

Required Calculator Inputs: historical proportion of customers that make a purchase, historical AOV

When measuring revenue by spend, we are simply looking how much money was spent by people receiving mailing A or B, or getting the piece vs being in the holdout group. This is measured by [total spend by all recipients]/[amount of recipients]. The total spend must be divided by the amount of recipients to account for (small) differences between the amount of people in each group.

This metric helps optimize ROI for mailings, as the costs per recipients are constant, meaning optimized ROI comes down to optimized spend per recipient.

In case of a holdout subgroup, substitute [recipients] by [people in the holdout list].

The tools and the methods of the present disclosure calculate the spend per customer as follows:

### Sample Size:

Where n=sample size, λ=proportion of customers who visited, θ=aggregate AOV, α=confidence level, and δ=minimum detectable difference

$$p = 1.4 * NormSInv ( 1 - ( \frac{1 - α}{2} ) )$$

$$z = λδ$$

$$c = 2 {λθ}^{2} ( 1 - λ )$$

$$q = 1.96 \\ d = 2 {λθ}^{2} {δ}^{2} ( 1 - λ ) \\ n = \frac{( 2 pq \sqrt{λ d} ) + ( λ {p}^{2} ) + ( {dq}^{2} ) )}{{z}^{2}}$$

### Probability P(A>B):

The spend generated by an individual user i is given by αᵢ*rᵢ, where

rᵢ<−Expon(θ)

αᵢ<−Bernoulli(λ)

θ is the average order value of the subjects under test. λ is the proportion of subjects under test who made a purchase. P(A>B) is computed with Monte Carlo sampling:

Draw samples θ_{A}ⁱ, θ_{B}ⁱ, λ_{A}ⁱ, λ_{B}ⁱ for i=1, . . . , N from the relevant distributions.

Count the number of samples for which λ_{A}ⁱ*θ_{A}ⁱ>λ_{B}ⁱ*θ_{B}ⁱ

Divide this count by M

### Lift:

Where Δ_{A} is lift generated by version A, θ_{B} is the aggregate AOV from version B, and N is the number of samples in the simulation

Draw samples θ_{A}ⁱ, θ_{B}ⁱ, λ_{A}ⁱ, λ_{B}ⁱ for i=1, . . . , N from the relevant distributions.

Compute the following:

$${Δ}_{A} = \frac{{θ}_{B} {λ}_{b}}{N} {\sum }_{i = 0}^{N} ( {λ}_{a}^{i} {θ}_{A}^{i} - {λ}_{b}^{i} {θ}_{B}^{i} )$$

### Example of Tools and Methods of the Present Disclosure for Determining Open Rate

Required Inputs: # of opens for A and B, # of not opens for A and B

Required Inputs for calculator: opens as a percentage (open rate)

The purpose of measuring with this metric is to get as many users to open the email as possible. This can be measured as [total amount of users that opened at least once]/[total amount of users that have the delivered event at least once].

As A/B tests use randomly selected subgroups, the percentage of deliveries out of the total should be expected to be the same in both groups. The only reason to get a non-delivered event is technical, and not related to the content/subject of the A or B message.

Optimizing for open rate is effectively the same as just optimizing the total amount of unique users with at least one open. It is still preferable to measure open rate, as we display open rate elsewhere in the portal as well.

The A/B testing tools and the methods of the present disclosure calculate the open rate as follows:

### Sample Size:

Where n=sample size, λ=aggregate open rate, α=confidence level, and δ=minimum detectable difference

$$p = 1.4 NormSInv ( 1 - ( \frac{1 - α}{2} ) )$$

$$c = λ ( 1 - λ )$$

$$d = ( λ + δ ) ( 1 - ( λ + δ ) )$$

$$n = \frac{( 2 pq \sqrt{cd} ) + ( {cp}^{2} ) + ( {dq}^{2} ) )}{{δ}^{2}}$$

### Probability P(A>B):

$$P ( {p}_{A} > {p}_{B} ) = 1 - {\sum }_{i = 0}^{{opens}_{B} - 1} \frac{B ( {opens}_{A} + i , {notopens}_{B} + {notopens}_{A} )}{( {notopens}_{B} + i ) B ( 1 + i , {notopens}_{B} ) B ( {opens}_{A} , {notopens}_{A} )}$$

### Lift:

Where Δ_{A}=lift generated by version A

$${Δ}_{A} = \frac{{opens}_{A} ( {opens}_{B} + {notopens}_{B} )}{{opens}_{B} ( {opens}_{A} + {notopens}_{A} )} - 1$$

### Example of Tools and Methods of the Present Disclosure for Determining Click Through Rate

Required Inputs: # of clicks for A and B, # of not clicks for A and B

Calculator Input: clicks as a percentage (open rate)

Similar to open rate, except measuring [total amount of users that clicked at least once]/[total amount of users that have the delivered event at least once].

The A/B testing tools and the methods of the present disclosure calculate the click through rate as follows:

### Sample Size:

Where n=sample size, λ=aggregate CTR, α=confidence level, and δ=minimum detectable difference

$$p = 1.4 NormSInv ( 1 - ( \frac{1 - α}{2} ) )$$

$$q = 1.96$$

$$c = λ ( 1 - λ )$$

$$d = ( λ + δ ) ( 1 - ( λ + δ ) ) \\ n = \frac{( 2 pq \sqrt{cd} ) + ( {cp}^{2} ) + ( {dq}^{2} )}{{δ}^{2}}$$

### Probability P(A>B):

$$P ( {p}_{A} > {p}_{B} ) = 1 - {\sum }_{i = 0}^{{clicks}_{B} - 1} \frac{B ( {clicks}_{A} + i , {notclicks}_{B} + {notclicks}_{A} )}{( {notclicks}_{B} + i ) B ( 1 + i , {notclicks}_{B} ) B ( {clicks}_{A} , {notclicks}_{A} )}$$

### Lift:

Where Δ_{A}=lift generated by version A

$$= {Δ}_{A} = \frac{{clicks}_{A} ( {clicks}_{B} + {notclicks}_{B} )}{{clicks}_{B} ( {clicks}_{A} + {notclicks}_{A} )} - 1$$

### CONCLUSION

In each of the examples above, it should be recognized that the sample size, probability, and lift are combined in new and unique ways to provide accuracy not previously possible, particularly in email testing.

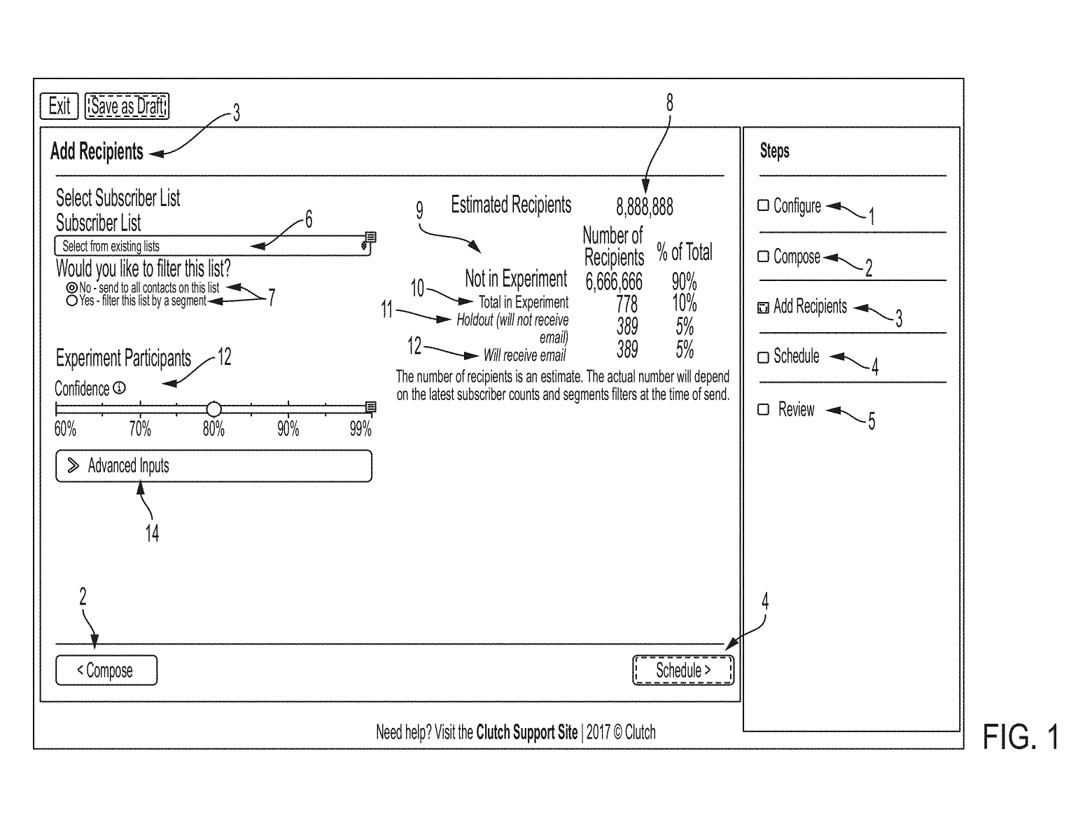

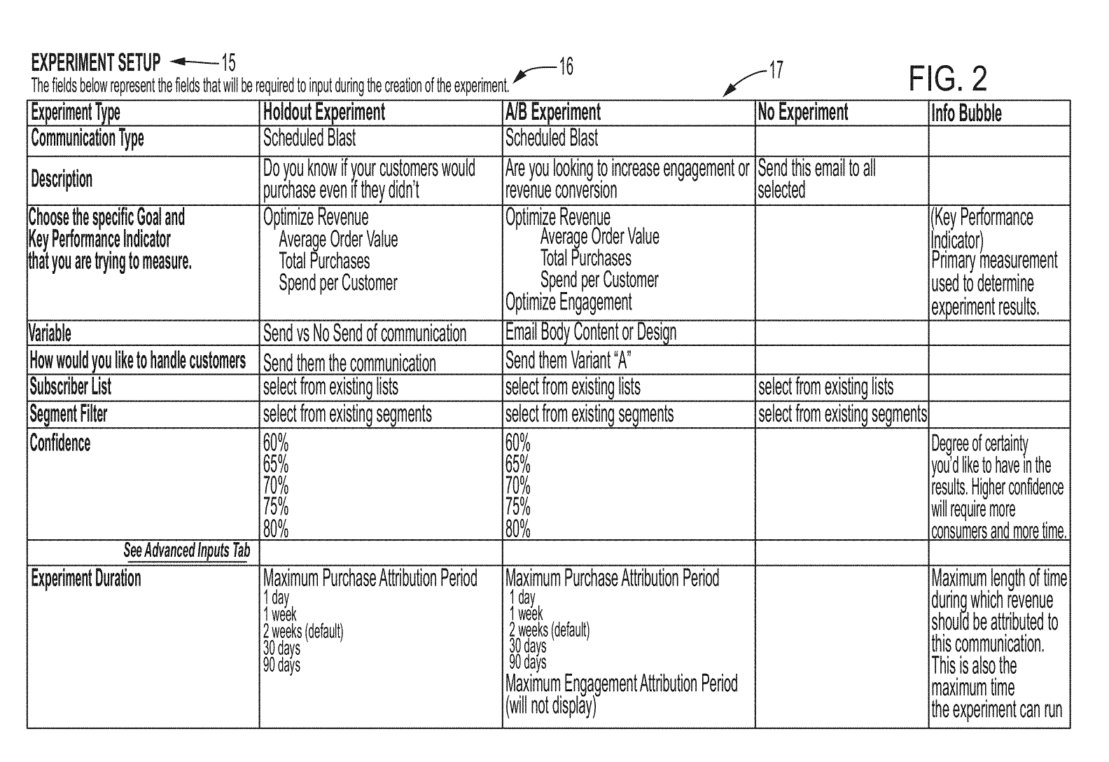

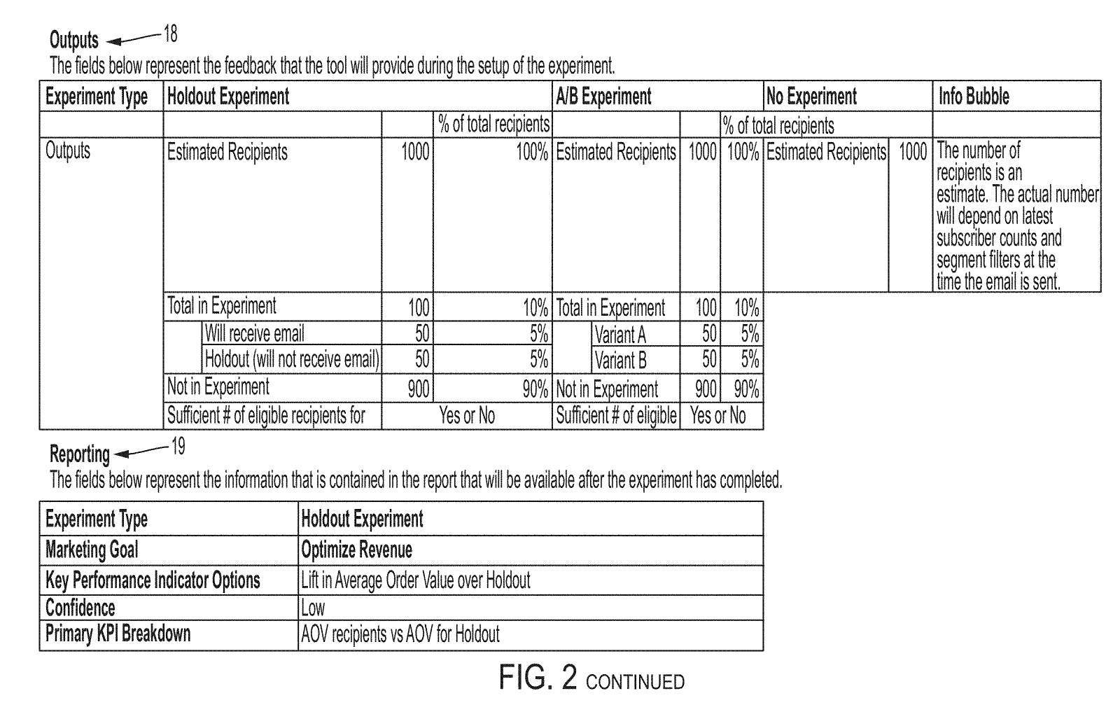

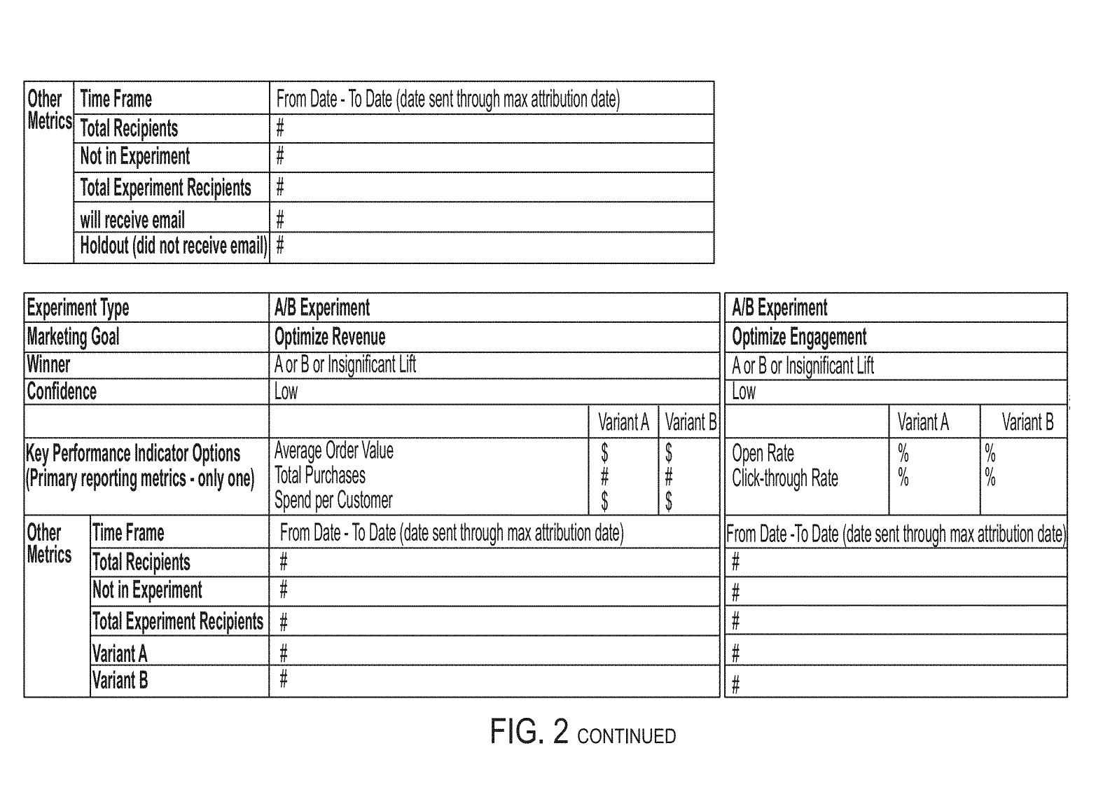

A better understanding of the A/B testing tools and methods of present disclosure can be had with review of FIGS. 1 and 2.

FIG. 1 illustrates an example A/B testing tool and method according to the present disclosure. Here, the tool allows a user to configure an email test (1), to compose the email (2), to add recipients to the email (3), to schedule delivery of the email (4), and to review the email test (5).

During the addition of recipients (3), the sample size selector of the present application is provided to the user. Here, the user can select from one or more existing subscriber list in drop down box (6) and based on the selection of one or more optional filters (7) is provided with an estimated number of recipients (8) of the email. The estimated number of recipients (8) can include, for example, the number of subscribers not in the experiment (9), the total number in the experiment (10), those holding out from the experiment (11), and those participating in the experiment (12).

Also, the user can adjust the confidence level (14)—using, for example, a sliding scale—of the email test outcomes.

In some embodiments, the user can adjust the one or more other advanced inputs (14).

In FIG. 2, the Experiment Setup (15) of the A/B testing tool and method, illustrates the possible parameters available for configuring an experiment, in the context of a preexisting email tool.

A holdout experiment (16) is a subset of A/B experiment (17) where the ‘B’ group is a control group.

The outputs (18) provides an example of what will be returned to the user after the experiment is set up, using a 10% sample of 1000 recipients.

In FIG. 2, reporting (19) describes what is returned to the user once the experiment has ended.

Advantageously, the A/B testing tools and methods of the present application solves difficult AB Testing problems related to email that are not encountered when AB Testing other content such as that in web pages or other live content.

The A/B testing tools and methods involve a combined application of three categories of new material: (1) Counting Events Asynchronously; (2) Sample Size Estimation in Bayesian Context for one-time mailings; and (3) How to stop an experiment run on recurring mailings. These and other problems resolved by the present application are encountered when running A/B test on content other than email.

The A/B testing tools and methods of the present application take two levels of asynchronicity into account when counting experiment events: (1) interaction level, and (2) purchase level.

The interaction level relates to live content in the email that is available for anybody to use. The question of whether somebody viewed, clicked, etc. or not this live content only depends on whether the relevant metrics have been logged. For an email use case, the mailing is sent and there is a wait to determine whether users to interact with it. This means a metric generating event is relative to a specified time period (attribution period).

The purchase level adds further complexity as compared to measurements of content such as a website. Here, the selection of a revenue-based metric requires waiting for a user to complete a purchase.

The present application tracks sales to determine when purchases are made and ties this purchase metric to the experiment.

The present application also considers the determination of the sample size. Websites are made live and then the number of samples of accessing the site are provided. The email of the present application is very different. For a scheduled email blast, it is necessary to know the number of mailings to send in advance. Sample size calculations are discussed above.

The present application further considers the stopping of the experiment. The system of the present application runs experiments dynamically based on the mailing—it does not use a predetermined sample size, which is contrary to prior systems.

An experiment based on a recurrent mailing is considered ‘stopped’ when the following three conditions have been met. First, it is determined whether the experiment has been running for at least a week. Next, it is determined that at least 50 samples have been collected for both variants, or for both the target and the holdout. For experiments with goal “exposure”, a card with a delivered event would be a sample. For experiments with goal “revenue”, a card with a purchase event would be a sample. The use of these exposures is a distinction that resolves issues not present in other content. Finally, the expected losses by choosing A (or B) are below our threshold of caring.

Advantageously, the experimentation engine of the present application implements the engine using Bayesian statistics.

It has been determined by the present application that the number of samples needed is not a critical concern. Rather, the present application estimates the number of samples beforehand and then determines if that number is enough for a good result. The present application can keep going if more samples are needed or stop early if less are needed. In contrast, the prior art uses the sample size as a critical concern—the needed sample size is calculated before test is run and requires that the sample size is met.

The measurements of the present application may vary over time so it is critical for the present application to use a data-dependent stopping rule to avoid false positives. Thus, the present application stops a test when there is a clear winner or run it for longer if you need more samples.

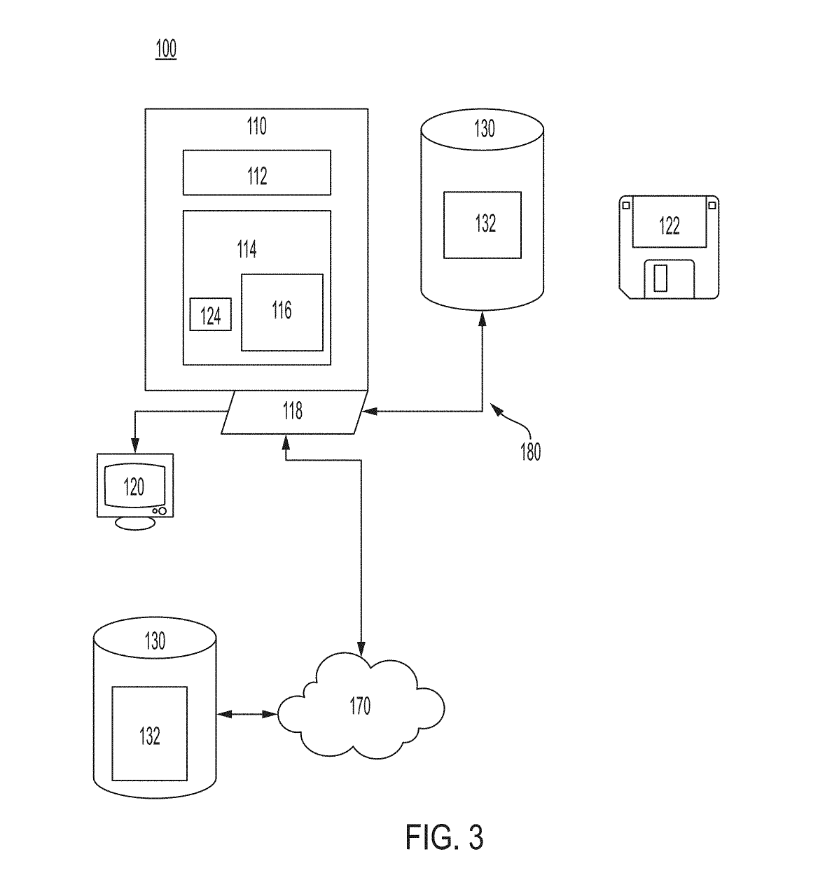

Referring now to FIG. 3, there is shown an A/B testing system 100 according to the present disclosure. System 100 includes a computer 110, an output device 120, and a database 130.

In some embodiments, database 130 is remote from computer 110. Here, computer 110 and database 130 are communicatively coupled via a network 170, e.g., the internet. Communications to and from network 170 and or are conducted using electronic or optical signals.

In other embodiments, database 130 is co-located with computer 110. Here, computer 110 and data base 130 are communicatively coupled via a local network or cable 180.

Computer 110 includes a processor 112, and a memory 114 coupled to the processor. Computer 110 can be a stand-alone device, but is not limited to such. Computer 110 can, instead, be coupled to other devices via a local network (not shown) or via network 170, in a distributed processing system.

Computer 110 also has an input/output interface 118 that can receive input from devices including a keyboard, a mouse, a scanner, a database, a storage device, a network interface card for communicating with network 170/180, and any other device or interface for providing an input to computer 110. Interface 118 can also output to devices, such as, a display 120, a printer, a database, a storage device, a network interface card for communicating with network 170/180, and any other device or interface to which computer 110 can output. A connection to network 170/180 via a network card, for example, is both an input and an output.

Processor 112 is an electronic device configured with logic circuitry that responds to and executes instructions.

Memory 114 is a tangible computer-readable storage device. In this regard, memory 114 stores data and instructions, i.e., program code, that are readable and executable by processor 112 for controlling the operation of the processor. Memory 114 can be implemented in a random-access memory (RAM), a hard drive, a read only memory (ROM), or a combination thereof. One of the components of memory 114 is a program module 116.

Program module 116 has instructions for controlling processor 112 to perform a method for A/B testing as described herein. The term “module” is used herein to denote a functional operation that can be embodied either as a stand-alone component or as an integrated configuration of a plurality of subordinate components. Thus, the program module can be implemented as a single module or as a plurality of modules that operate in cooperation with one another. Moreover, although the program module is described herein as being installed in memory, and therefore being implemented in software, it could be implemented in any of hardware (e.g., electronic circuitry), firmware, software, or a combination thereof.

In some embodiments, memory 114 can also include an email tool module 124 for generating emails used in combination with program module 116. In still other embodiments, program module 116 includes the email tool module 124.

While program module 116 and/or email tool module 124 are indicated as being already loaded into memory, one or both of the modules can be configured on a storage device 122 for subsequent loading into memory. Storage device 122 is a tangible computer-readable storage device that stores a version of the program module(s) thereon. Examples of storage device include, but are not limited to, a compact disc, a magnetic tape, a ROM, an optical storage media, a hard disk drive, a solid-state drive, a memory unit consisting of multiple parallel hard drives, and a universal serial bus (USB) flash drive. Alternatively, the storage device can be a random-access memory, or other type of electronic storage device, located on a remote storage system and coupled to the computer via network 170/180.

As discussed above, system 100 also includes database 130 that is communicatively coupled to computer 110. Database 130 has records 132 therein where record stores and identifies information as described in the present disclosure as being used by the A/B testing. Database 130 can be more than one separate database and on more than one storage device. Database 130 can be a relational database, a graph database, and the like.

It should also be noted that the terms “first”, “second”, “third”, “upper”, “lower”, and the like can be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes can be made and equivalents can be substituted for elements thereof without departing from the scope of the present disclosure. In addition, many modifications can be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A computer-implemented method for Bayesian A/B testing of emails, the method comprising:
configuring an email experiment that determines one or more different key performance indicators of the email experiment from a sample size, a probability, and a lift;
adjusting a confidence level of the email experiment;
composing an email for the email experiment;
adding recipients to the email, the step of adding the recipients comprises using a sample size selector to select from the users from one or more existing subscriber lists and estimating an estimated number of recipients of the email;
scheduling delivery of the email, and
reporting results of the email experiment.

2. The method of claim 1, wherein the one or more different key performance indicators are selected from the group consisting of average order value, total purchases, spend per customer, open rate, click through rate, and any combinations thereof.

3. The method of claim 2, wherein the estimated number of recipients includes an estimates number of subscribers not in the experiment, an estimated total number of users in the experiment, an estimated number of users holding out from the experiment, and an estimated number of users participating in the experiment.

4. The method of claim 3, wherein the email experiment comprises taking two levels of asynchronicity into account when counting experiment events, wherein the two levels comprise an interaction level and a purchase level.

5. The method of claim 4, wherein the interaction level is determined relative to a specified time period.

6. The method of claim 4, wherein the purchase level is determined relative to a user completing a purchase.

7. The method of claim 3, wherein the email experiment does not use a predetermined sample size.

8. The method of claim 3, further comprising stopping the email experiment based on: whether the email experiment has been running for at least a week, whether at least 50 samples have been collected for both a target and a holdout, and whether the expected losses are below a threshold of caring.

9. A computer system for Bayesian A/B testing of emails, the system comprising:
a processor; and
a tangible memory storage having instructions that cause the computer system to:
configuring an email experiment that determines one or more different key performance indicators of the email experiment from a sample size, a probability, and a lift;
adjusting a confidence level of the email experiment;
composing an email for the email experiment;
adding recipients to the email, the step of adding the recipients comprises using a sample size selector to select from the users from one or more existing subscriber lists and estimating an estimated number of recipients of the email;
scheduling delivery of the email, and
reporting results of the email experiment.

10. The method of claim 9, wherein the one or more different key performance indicators are selected from the group consisting of average order value, total purchases, spend per customer, open rate, click through rate, and any combinations thereof.

11. The method of claim 10, wherein the estimated number of recipients includes an estimates number of subscribers not in the experiment, an estimated total number of users in the experiment, an estimated number of users holding out from the experiment, and an estimated number of users participating in the experiment.

12. The method of claim 11, wherein the email experiment comprises taking two levels of asynchronicity into account when counting experiment events, wherein the two levels comprise an interaction level and a purchase level.

13. The method of claim 12, wherein the interaction level is determined relative to a specified time period.

14. The method of claim 11, wherein the purchase level is determined relative to a user completing a purchase.

15. The method of claim 11, wherein the email experiment does not use a predetermined sample size.

16. The method of claim 11, further comprising stopping the email experiment based on: whether the email experiment has been running for at least a week, whether at least 50 samples have been collected for both a target and a holdout, and whether the expected losses are below a threshold of caring.
